(19) United States
(12) Patent Application Publication
(10) Pub. No.: US 2016/0131223 A1
(43) Pub. Date: May 12, 2016

(54) TRANSMISSION WITH DUAL INPUT AND REDUCED NUMBER OF LAY SHAFTS

(71) Applicant: Schaeffler Technologies GmbH & Co. KG, Herzogenaurach (DE)

(72) Inventors: Jeffrey Hemphill, Copley, OH (US); David Smith, Wadsworth, OH (US); Edmund Maucher, Jeromesville, OH (US)

(21) Appl. No.: 14/534,584

(22) Filed: Nov. 6, 2014

(51) Int. Cl. F16H 3/097; F16H 3/00

(52) U.S. Cl. CPC F16H 3/097; F16H 3/006; F16H 2200/0008; F16H 2003/0818

(57) ABSTRACT

A transmission including: first and second input shafts; an output shaft; lay shafts; gears; and at least one forward output gear non-rotatably connected to the output shaft; an axis of rotation for each gear; half synchronizer clutches arranged to non-rotatably connect the gears to lay shafts and disconnect the gears from the lay shafts; and an idler gear non-rotatably connected to a lay shaft and meshed with the at least one forward output gear so that when the idler gear rotates about its axis of rotation, the at least one forward output gear rotates about its axis of rotation and when the at least one forward output gear rotates about its axis of rotation, the idler gear rotates about its axis of rotation. For at least one reverse gear ratio, the idler gear is arranged to rotate the output shaft opposite a direction of rotation for the first or second input shaft.

### TECHNICAL FIELD

The present disclosure relates to a transmission with a dual input and a reduced size and footprint, in particular with a reduced number of shafts, specifically, including an idler gear, for reverse gear ratios, non-rotatably connected to a lay shaft used for forward gear ratios.

### BACKGROUND

It is desirable to reduce the space required for a transmission, in particular for front wheel drive vehicles. Many known power shift transmissions use basic manual transmission architecture with a double clutch system as input. However, the architecture requires a relatively long axial installation space. The space required for the transmission also is a function of the number of gear shafts in the transmission. Specifically, the greater the number of gear shafts, the greater the amount of space required. Further, known dual clutch transmissions include an idler gear, for reverse gear or gears, non-rotatably connected to a shaft different from lay shafts used for forward gear ratios. The space required to accommodate the basic manual transmission architecture and various gear shafts limits the number of gear ratios possible for a transmission.

### SUMMARY

According to aspects illustrated herein, there is provided a transmission, including: first and second input shafts; an output shaft; a plurality of lay shafts; a plurality of gears; an at least one forward output gear non-rotatably connected to the output shaft; a respective axis of rotation for each gear in the plurality of gears; a plurality of half synchronizer clutches arranged to non-rotatably connect the plurality of gears to the plurality of lay shafts and disconnect the plurality of gears from the plurality of lay shafts; and an idler gear non-rotatably connected to a lay shaft included in the plurality of lay shafts and meshed with the at least one forward output gear so that when the idler gear rotates about its axis of rotation, the at least one forward output gear rotates about its axis of rotation and when the at least one forward output gear rotates about its axis of rotation, the idler gear rotates about its axis of rotation. For at least one reverse gear ratio, the idler gear is arranged to rotate the output shaft opposite a direction of rotation for the first or second input shaft.

According to aspects illustrated herein, there is provided a transmission including: first and second input shafts; an output shaft; a plurality of lay shafts; a plurality of gears; at least one forward output gear non-rotatably connected to the output shaft; a respective axis of rotation for each gear in the plurality of gears; a plurality of half synchronizer clutches arranged to non-rotatably connect the plurality of gears to the plurality of lay shafts and disconnect the plurality of gears from the plurality of lay shafts; and an idler gear arranged to reverse a rotational direction of torque received by the first or second input shaft, non-rotatably connected to a lay shaft included in the plurality of lay shafts, and meshed with the at least one forward output gear so that when the idler gear rotates about its axis of rotation, the output shaft rotates and when the output shaft rotates, the idler gear rotates about its axis of rotation. For a first reverse gear ratio, first torque from the first input shaft to the output shaft passes through the idler gear. For a second reverse gear ratio, second torque from the second input shaft to the output shaft passes through the idler gear.

According to aspects illustrated herein, there is provided a transmission including: a total number of inputs shafts equal to a first number; one only output shaft; a total number of lay shafts equal to a second number; a plurality of gears for providing forward gear ratios in which the output shaft rotates in a same direction as the first or second input shaft; a total number of forward output gears, non-rotatably connected to the one only output gear, equal to a third number; a plurality of half synchronizer clutches arranged to non-rotatably connect the plurality of gears to the plurality of lay shafts and disconnect the plurality of gears from the plurality of lay shafts; and one only idler gear arranged to reverse a rotational direction of torque received by the first or second input shaft, non-rotatably connected to a lay shaft included in the plurality of lay shafts, and meshed with the at least one forward output gear so that when the idler gear rotates about its axis of rotation, the one only output shaft rotates and when the one only output shaft rotates, the idler gear rotates about its axis of rotation. The plurality of half synchronizer clutches includes a fourth number of half synchronizer clutches arranged to non-rotatably connect the output shaft to an input shaft. Each forward output gear is non-rotatably connected to the output shaft and meshed with a respective gear from the plurality of gears so that when said each forward output gear rotates about its axis of rotation, the respective gear rotates about its axis of rotation and when the respective gear rotates about its axis of rotation, the at least one forward output gear rotates about its axis of rotation. A total number of forward speed ratios for the transmission is equal to a sum of a first product of [(the first number)×(the second number)×(the third number)] and a second product of [(two)×(the fourth number)].

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a schematic diagram of a transmission assembly including a dual clutch input, six forward speeds and two reverse speeds;

FIG. 2 is a schematic diagram of a transmission assembly including a dual clutch input, eight forward speeds and two reverse speeds;

FIG. 3 is a schematic diagram of a transmission assembly including a dual clutch input, ten forward speeds and two reverse speeds;

FIG. 4 is a schematic diagram of a transmission assembly including a dual clutch input, ten forward speeds, two reverse speeds and front-wheel drive;

FIG. 5 is a schematic diagram of a transmission assembly including a dual clutch input, 12 forward speeds and two reverse speeds; and,

FIG. 6 is a schematic diagram of a transmission assembly including a dual clutch input, 14 forward speeds and two reverse speeds.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

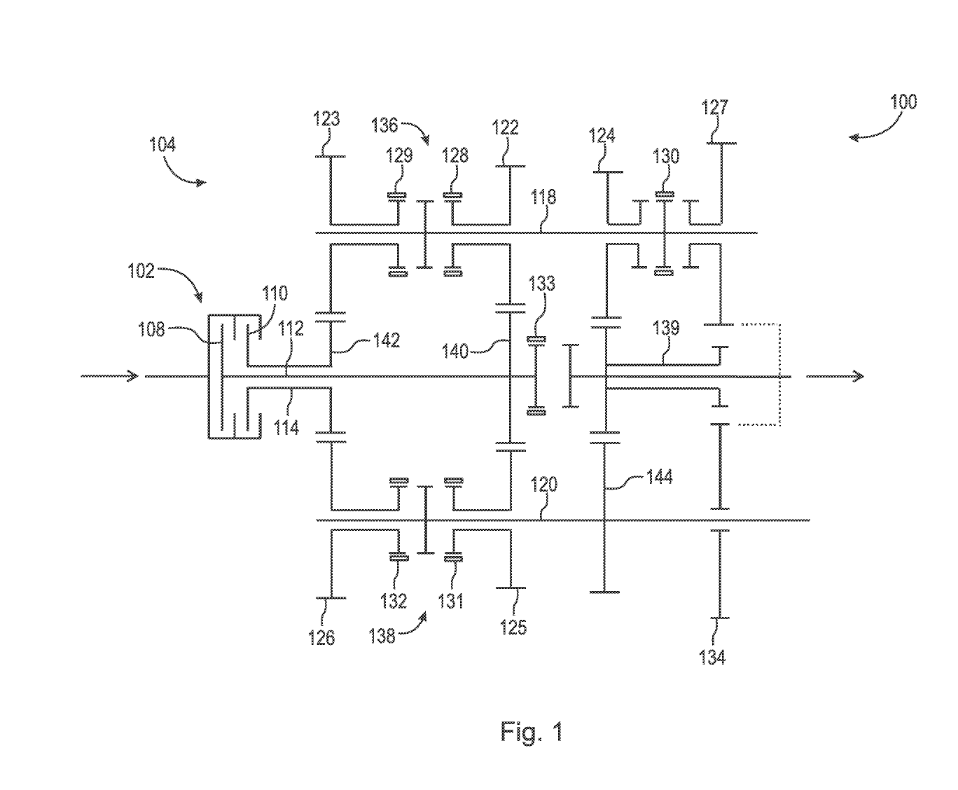

FIG. 1 is a schematic diagram of transmission assembly 100 including a dual clutch input, six forward speeds and two reverse speeds. Assembly 100 includes dual clutch assembly 102 and transmission 104. Assembly 102 includes torque input shaft 106 and clutches 108 and 110. Transmission 104 includes input shaft 112 connected to clutch 108 and input shaft 114 connected to clutch 110. When clutch 108 is closed, torque is transmitted from shaft 106 to shaft 112 via clutch 108. When clutch 110 is closed, torque is transmitted from shaft 106 to shaft 114 via clutch 110.

Transmission 104 includes: output shaft 116; lay shafts 118 and 120; gears 122 through 127; half synchronizer clutches 128 through 133; and idler gear 134 non-rotatably connected to lay shaft 120. Half synchronizer clutches 128 and 129 form full synchronizer clutch 136 and are arranged to: non-rotatably connect gears 122 and 123, respectively, to lay shaft 118; and disconnect gears 122 and 123, respectively, from lay shaft 118. Half synchronizer clutch 130 is arranged to: non-rotatably connect gears 124 and 127 to lay shaft 118, and disconnect gears 124 and 127 from lay shaft 118. Half synchronizer clutches 131 and 132 form full synchronizer clutch 138 and are arranged to: non-rotatably connect gears 125 and 126, respectively, to lay shaft 120; and disconnect gears 125 and 126, respectively, from lay shaft 120. Half synchronizer clutch 133 is arranged to non-rotatably connect input shaft 112 to output shaft 116 and disconnect shaft 112 from shaft 116. Transmission 104 includes forward output gear 139. By “forward output gear” we mean a gear non-rotatably connected to the output shaft and meshed with a gear arranged to provide a forward gear ratio. For example, gear 139 is meshed with gear 124. By “meshed with” we mean that two gears are engaged such that rotation of one gear causes rotation of the other gear and vice versa. Gear 139 also is meshed with gear 127 arranged to provide at least one reverse gear ratio.

In an example embodiment, transmission 104 includes gears 140, 142 and 144 non-rotatably connected to shafts 112, 114 and 120, respectively. Forward output gear 139 is meshed with gear 144. Gear 140 is meshed with gears 122 and 125 and gear 142 is meshed with gears 123 and 126.

Assembly 100 is arranged to provide gear ratios as follows:

1. First forward gear ratio: Close clutches 108, 128 and 130; and non-rotatably connect gears 122 and 124 to lay shaft 118.

2. Second forward gear ratio: Close clutches 110, 129 and 130; and non-rotatably connect gears 123 and 124 to lay shaft 118.

3. Third forward gear ratio: Close clutches 108 and 131; and non-rotatably connect gear 125 to lay shaft 120.

4. Fourth forward gear ratio: Close clutches 110 and 132; and non-rotatably connect gear 126 to lay shaft 120.

5. Fifth forward gear ratio: Close clutches 108 and 133; and non-rotatably connect input shaft 112 to output shaft 116.

6. Sixth forward gear ratio: Close clutches 110, 136 and 133; non-rotatably connect input shaft 114 to output shaft 116; and create a torque path through full synchronizer 136.

7. First reverse gear ratio: Close clutches 108, 128 and 130; and non-rotatably connect gears 122 and 127 to lay shaft 118.

8. Second reverse gear ratio: Close clutches 110, 129 and 130; and non-rotatably connect gears 123 and 127 to lay shaft 118.

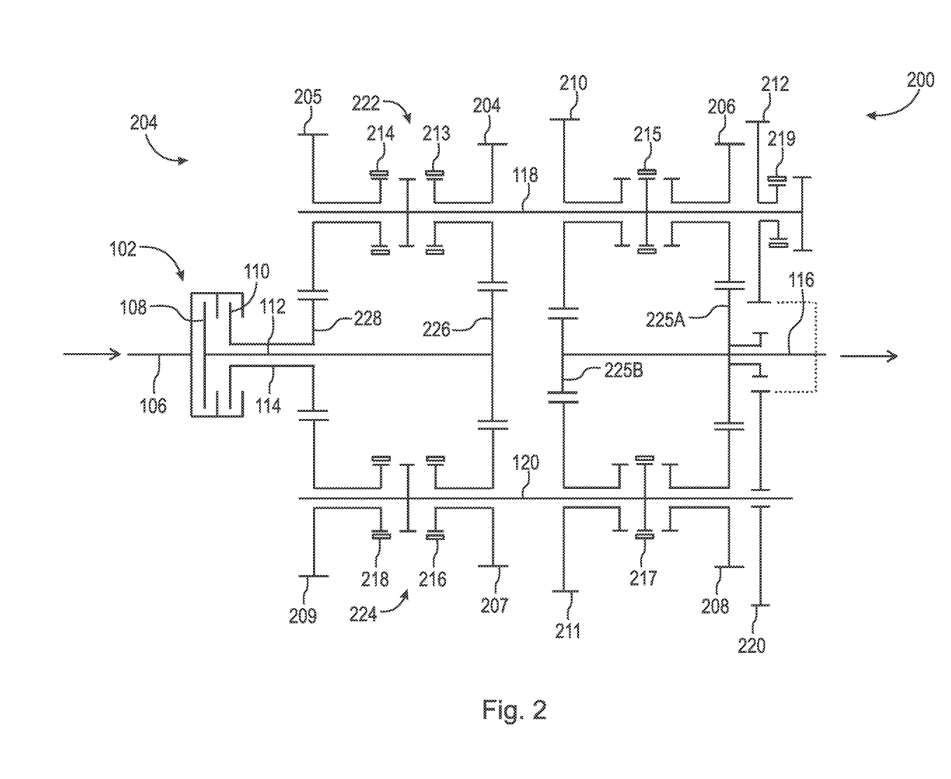

FIG. 2 is a schematic diagram of transmission assembly 200 including a dual clutch input, eight forward speeds and two reverse speeds. Assembly 200 includes dual clutch assembly 102 and transmission 204. Transmission 204 includes: output shaft 116; lay shafts 118 and 120; gears 204 through 212; half synchronizer clutches 213 through 219; and idler gear 220 non-rotatably connected to lay shaft 120. Half synchronizer clutches 213 and 214 form full synchronizer clutch 222 and are arranged to: non-rotatably connect gears 204 and 205, respectively, to lay shaft 118; and disconnect gears 204 and 205, respectively, from lay shaft 118. Half synchronizer clutch 215 is arranged to: non-rotatably connect gears 206 and 210 to lay shaft 118, and disconnect gears 206 and 210 from lay shaft 118. Half synchronizer clutches 216 and 218 form full synchronizer clutch 224 and are arranged to: non-rotatably connect gears 207 and 209, respectively, to lay shaft 120; and disconnect gears 207 and 209, respectively, from lay shaft 120. Half synchronizer clutch 217 is arranged to: non-rotatably connect gears 211 and 208 to lay shaft 120, and disconnect gears 211 and 208 from lay shaft 120. Half synchronizer clutch 219 is arranged to: non-rotatably connect gear 212 to lay shaft 118, and disconnect gear 212 from lay shaft 118. Transmission 204 includes forward output gears 225A and 225B. Gear 225A is meshed with gears 206 and 208. Gear 225B is meshed with gears 210 and 211. Gear 225A also is meshed with gear 212 arranged to provide at least one reverse gear ratio.

In an example embodiment, transmission 104 includes gears 226 and 228 non-rotatably connected to shafts 112 and 114, respectively. Gear 226 is meshed with gears 204 and 207 and gear 228 is meshed with gears 205 and 209.

Assembly 200 is arranged to provide gear ratios as follows:

1. First forward gear ratio: Close clutches 108, 213 and 215; and non-rotatably connect gears 204 and 206 to lay shaft 118.

2. Second forward gear ratio: Close clutches 110, 214 and 215; and non-rotatably connect gears 205 and 206 to lay shaft 118.

3. Third forward gear ratio: Close clutches 108, 216 and 217; and non-rotatably connect gears 207 and 208 to lay shaft 120.

4. Fourth forward gear ratio: Close clutches 110, 218 and 217; and non-rotatably connect gears 209 and 208 to lay shaft 120.

5. Fifth forward gear ratio: Close clutches 108, 213 and 215; and non-rotatably connect gears 204 and 210 to shaft 118.

6. Sixth forward gear ratio: Close clutches 110, 214 and 215; and non-rotatably connect gears 205 and 210 to shaft 118.

7. Seventh forward gear ratio: Close clutches 108, 216 and 217; and non-rotatably connect gears 207 and 211 to lay shaft 120.

8. Eighth forward gear ratio: Close clutches 110, 218 and 217; and non-rotatably connect gears 209 and 211 to lay shaft 120.

9. First reverse gear ratio: Close clutches 108, 213 and 219; and non-rotatably connect gears 204 and 212 to lay shaft 118.

10. Second reverse gear ratio: Close clutches 110, 214 and 219; and non-rotatably connect gears 205 and 212 to lay shaft 118.

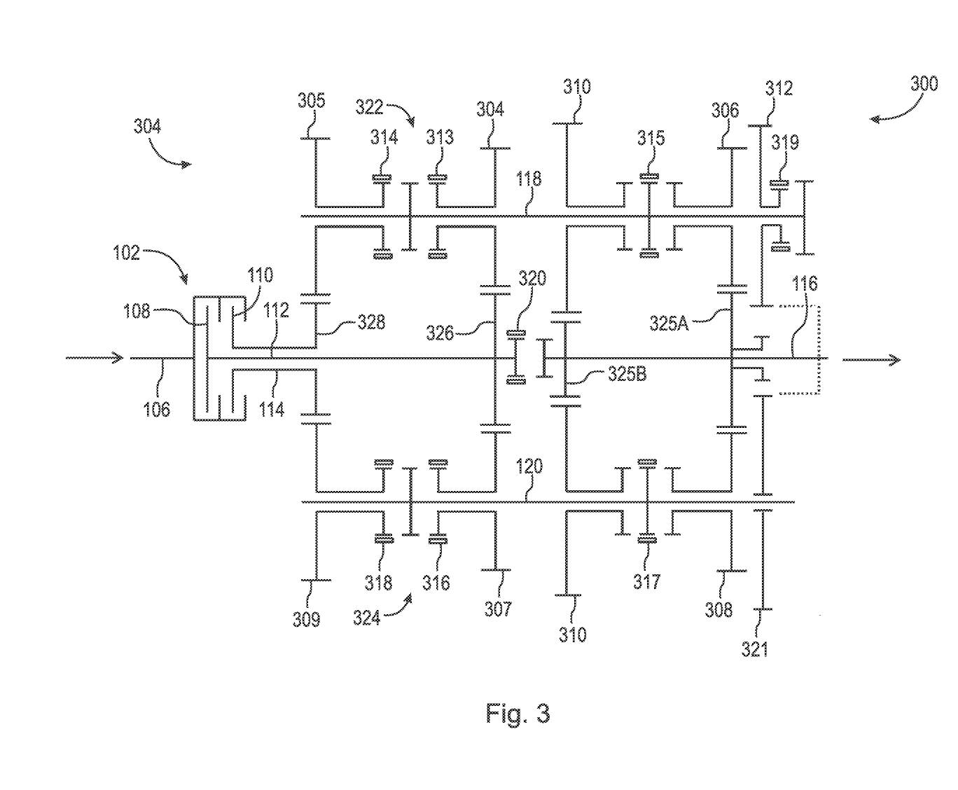

FIG. 3 is a schematic diagram of transmission assembly 300 including a dual clutch input, ten forward speeds and two reverse speeds. Assembly 300 includes dual clutch assembly 102 and transmission 304. Transmission 304 includes: output shaft 116; lay shafts 118 and 120; gears 304 through 312; half synchronizer clutches 313 through 320; and idler gear 321 non-rotatably connected to lay shaft 120. Half synchronizer clutches 313 and 314 form full synchronizer clutch 322 and are arranged to: non-rotatably connect gears 304 and 305, respectively, to lay shaft 118; and disconnect gears 304 and 305, respectively, from lay shaft 118. Half synchronizer clutch 315 is arranged to: non-rotatably connect gears 306 and 310 to lay shaft 118, and disconnect gears 306 and 310 from lay shaft 118. Half synchronizer clutches 316 and 318 form full synchronizer clutch 324 and are arranged to: non-rotatably connect gears 307 and 309, respectively, to lay shaft 120; and disconnect gears 307 and 309, respectively, from lay shaft 120. Half synchronizer clutch 317 is arranged to: non-rotatably connect gears 308 and 310 to lay shaft 120, and disconnect gears 308 and 310 from lay shaft 120. Half synchronizer clutch 319 is arranged to: non-rotatably connect gear 312 to lay shaft 118, and disconnect gear 312 from lay shaft 118. Half synchronizer clutch 320 is arranged to: non-rotatably connect input shaft 112 and output shaft 116 and disconnect shafts 112 and 116. Transmission 304 includes forward output gears 325A and 325B. Gear 325A is meshed with gears 306 and 308. Gear 325B is meshed with gears 310 and 311. Gear 325A also is meshed with gear 312 arranged to provide at least one reverse gear ratio.

In an example embodiment, transmission 104 includes gears 326 and 328 non-rotatably connected to shafts 112 and 114, respectively. Gear 326 is meshed with gears 304 and 307 and gear 328 is meshed with gears 305 and 309.

Assembly 300 is arranged to provide gear ratios as follows:

1. First forward gear ratio: Close clutches 108, 313 and 315; and non-rotatably connect gears 304 and 306 to lay shaft 118.

2. Second forward gear ratio: Close clutches 110, 314 and 315; and non-rotatably connect gears 305 and 306 to lay shaft 118.

3. Third forward gear ratio: Close clutches 108, 316 and 317; and non-rotatably connect gears 307 and 308 to lay shaft 120.

4. Fourth forward gear ratio: Close clutches 110, 318 and 317; and non-rotatably connect gears 309 and 308 to lay shaft 120.

5. Fifth forward gear ratio: Close clutches 108, 313 and 315; and non-rotatably connect gears 304 and 310 to shaft 118.

6. Sixth forward gear ratio: Close clutches 110, 314 and 315; and non-rotatably connect gears 305 and 310 to shaft 118.

7. Seventh forward gear ratio: Close clutches 108, 316 and 317; and non-rotatably connect gears 307 and 310 to lay shaft 120.

8. Eighth forward gear ratio: Close clutches 110, 318 and 317; and non-rotatably connect gears 309 and 310 to lay shaft 120.

9. Ninth forward gear ratio: Close clutches 108 and 320 to non-rotatably connect input shaft 112 and output shaft 116.

10. Tenth forward gear ratio: close clutches 110, 324 and 320 to create a torque path through clutch 324 and non-rotatably connect input shaft 112 and output shaft 116.

9. First reverse gear ratio: Close clutches 108, 313 and 319; and non-rotatably connect gears 304 and 312 to lay shaft 118.

10. Second reverse gear ratio: Close clutches 110, 314 and 319; and non-rotatably connect gears 305 and 312 to lay shaft 118.

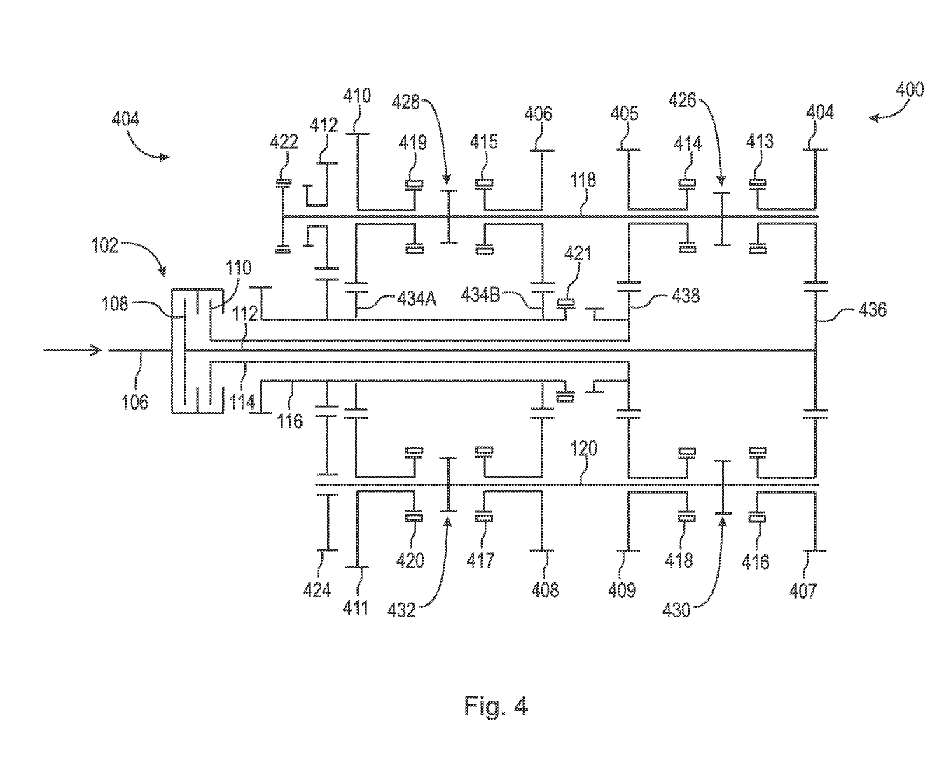

FIG. 4 is a schematic diagram of transmission assembly 400 including a dual clutch input, ten forward speeds, two reverse speeds and front-wheel drive. Assembly 400 includes dual clutch assembly 102 and transmission 404. Transmission 404 includes: output shaft 116; lay shafts 118 and 120; gears 404 through 412; half synchronizer clutches 413 through 422; and idler gear 424 non-rotatably connected to lay shaft 120. Half synchronizer clutches 413 and 414 form full synchronizer clutch 426 and are arranged to: non-rotatably connect gears 404 and 405, respectively, to lay shaft 118; and disconnect gears 404 and 405, respectively, from lay shaft 118. Half synchronizer clutches 415 and 419 form full synchronizer clutch 428 and are arranged to: non-rotatably connect gears 406 and 410, respectively, to lay shaft 118; and disconnect gears 406 and 410, respectively, from lay shaft 118. Half synchronizer clutches 416 and 418 form full synchronizer clutch 430 and are arranged to: non-rotatably connect gears 407 and 409, respectively, to lay shaft 120; and disconnect gears 407 and 409, respectively, from lay shaft 120. Half synchronizer clutches 417 and 420 form full synchronizer clutch 432 and are arranged to: non-rotatably connect gears 408 and 411, respectively, to lay shaft 120; and disconnect gears 408 and 411, respectively, from lay shaft 120. Half synchronizer clutch 421 is arranged to: non-rotatably connect input shaft 112 and output shaft 116. Half synchronizer clutch 422 is arranged to: non-rotatably connect gear 412 to lay shaft 118, and disconnect gear 412 from lay shaft 118. Transmission 404 includes forward output gears 434A and 434B. Gear 434A is meshed with gears 410 and 411. Gear 434B is meshed with gears 406 and 408. Gear 434A also is meshed with gear 412 arranged to provide at least one reverse gear ratio.

In an example embodiment, transmission 104 includes gears 436 and 438 non-rotatably connected to shafts 112 and 114, respectively. Gear 436 is meshed with gears 404 and 407 and gear 438 is meshed with gears 405 and 409.

Assembly 400 is arranged to provide gear ratios as follows:

1. First forward gear ratio: Close clutches 108, 413 and 415; and non-rotatably connect gears 404 and 406 to lay shaft 118.

2. Second forward gear ratio: Close clutches 110, 414 and 415; and non-rotatably connect gears 405 and 406 to lay shaft 118.

3. Third forward gear ratio: Close clutches 108, 416 and 417; and non-rotatably connect gears 407 and 408 to lay shaft 120.

4. Fourth forward gear ratio: Close clutches 110, 418 and 417; and non-rotatably connect gears 409 and 408 to lay shaft 120.

5. Fifth forward gear ratio: Close clutches 108, 413 and 419; and non-rotatably connect gears 404 and 410 to shaft 118.

6. Sixth forward gear ratio: Close clutches 110, 414 and 419; and non-rotatably connect gears 405 and 410 to shaft 118.

7. Seventh forward gear ratio: Close clutches 108, 416 and 420; and non-rotatably connect gears 407 and 411 to lay shaft 120.

8. Eighth forward gear ratio: Close clutches 110, 418 and 411; and non-rotatably connect gears 409 and 411 to lay shaft 120.

9. Ninth forward gear ratio: Close clutches 108, 426 and 421.

10. Tenth forward gear ratio: close clutches 110 and 426 to non-rotatably connect input shaft 114 and output shaft 116.

9. First reverse gear ratio: Close clutches 108, 413 and 422; and non-rotatably connect gears 404 and 412 to lay shaft 118.

10. Second reverse gear ratio: Close clutches 110, 414 and 422; and non-rotatably connect gears 405 and 412 to lay shaft 118.

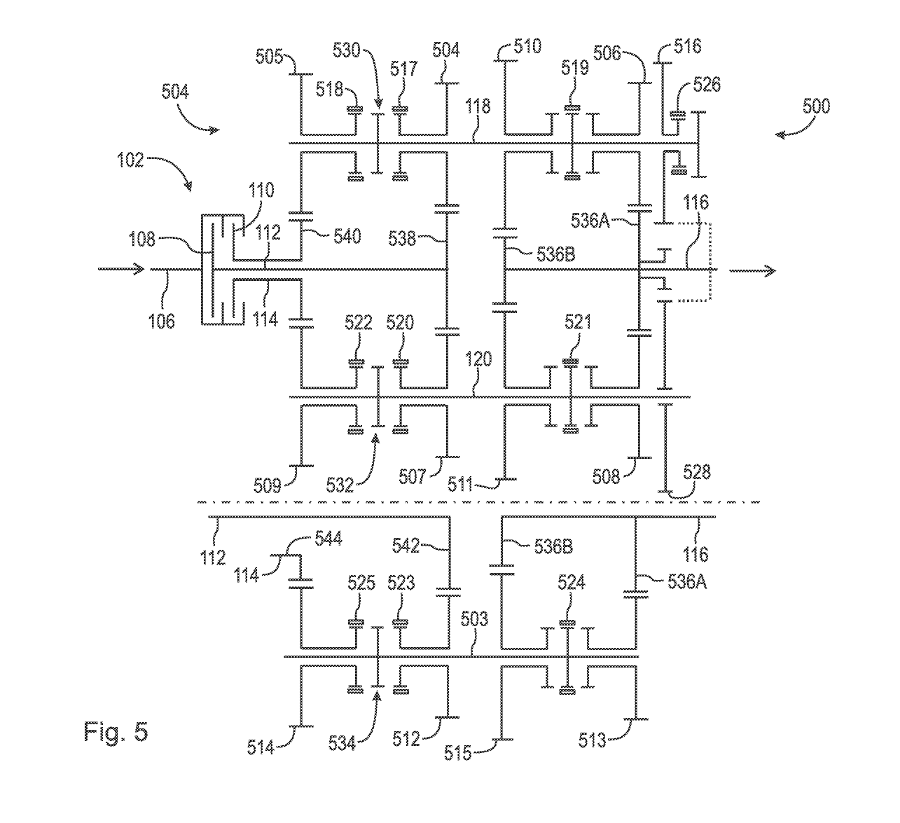

FIG. 5 is a schematic diagram of transmission assembly 500 including a dual clutch input, 12 forward speeds and two reverse speeds. Assembly 500 includes dual clutch assembly 102 and transmission 504. Transmission 504 includes: output shaft 116; lay shafts 118 and 120; lay shaft 503; gears 504 through 516; half synchronizer clutches 517 through 526; and idler gear 528 non-rotatably connected to lay shaft 120. Half synchronizer clutches 517 and 518 form full synchronizer clutch 530 and are arranged to: non-rotatably connect gears 504 and 505, respectively, to lay shaft 118; and disconnect gears 504 and 505, respectively, from lay shaft 118. Half synchronizer clutch 519 is arranged to: non-rotatably connect gears 506 and 510 to lay shaft 118, and disconnect gears 506 and 510 from lay shaft 118. Half synchronizer clutches 520 and 522 form full synchronizer clutch 532 and are arranged to: non-rotatably connect gears 507 and 509, respectively, to lay shaft 120; and disconnect gears 507 and 509, respectively, from lay shaft 120. Half synchronizer clutch 521 is arranged to: non-rotatably connect gears 508 and 511 to lay shaft 120, and disconnect gear 508 and 511 from lay shaft 118. Half synchronizer clutches 523 and 525 form full synchronizer clutch 534 and are arranged to: non-rotatably connect gears 512 and 514, respectively, to lay shaft 503; and disconnect gears 512 and 514, respectively, from lay shaft 503. Half synchronizer clutch 524 is arranged to: non-rotatably connect gears 513 and 515 to lay shaft 503, and disconnect gear 513 and 515 from lay shaft 503. Transmission 504 includes forward output gears 536A and 536B. Gear 536A is meshed with gears 506, 508 and 513. Gear 534B is meshed with gears 510, 511 and 515.

In an example embodiment, transmission 104 includes gears 538, 540, 542, and 544 non-rotatably connected to shafts 112, 114, 112, and 114, respectively. Gear 538 is meshed with gears 504 and 507, gear 540 is meshed with gears 505 and 509, gear 542 is meshed with gear 512, and gear 544 is meshed with gear 514.

Assembly 500 is arranged to provide gear ratios as follows:

1. First forward gear ratio: Close clutches 108, 517 and 519; and non-rotatably connect gears 504 and 506 to lay shaft 118.

2. Second forward gear ratio: Close clutches 110, 518 and 519; and non-rotatably connect gears 505 and 506 to lay shaft 118.

3. Third forward gear ratio: Close clutches 108, 520 and 521; and non-rotatably connect gears 507 and 508 to lay shaft 120.

4. Fourth forward gear ratio: Close clutches 110, 522 and 521; and non-rotatably connect gears 509 and 508 to lay shaft 120.

5. Fifth forward gear ratio: Close clutches 108, 517 and 519; and non-rotatably connect gears 504 and 510 to shaft 118.

6. Sixth forward gear ratio: Close clutches 110, 518 and 519; and non-rotatably connect gears 505 and 510 to shaft 118.

7. Seventh forward gear ratio: Close clutches 108, 520 and 521; and non-rotatably connect gears 507 and 511 to lay shaft 120.

8. Eighth forward gear ratio: Close clutches 110, 522 and 521; and non-rotatably connect gears 509 and 511 to lay shaft 120.

9. Ninth forward gear ratio: Close clutches 108, 523 and 524; and non-rotatably connect gears 512 and 513 to lay shaft 503.

10. Tenth forward gear ratio: Close clutches 110, 525 and 524; and non-rotatably connect gears 514 and 513 to lay shaft 120.

11. Eleventh forward gear ratio: Close clutches 108, 523 and 524; and non-rotatably connect gears 512 and 515 to lay shaft 503.

12. Twelfth forward gear ratio: Close clutches 110, 525 and 524; and non-rotatably connect gears 514 and 515 to lay shaft 120.

13. First reverse gear ratio: Close clutches 108, 517 and 526; and non-rotatably connect gears 504 and 516 to lay shaft 118.

14. Second reverse gear ratio: Close clutches 110, 518 and 526; and non-rotatably connect gears 505 and 516 to lay shaft 118.

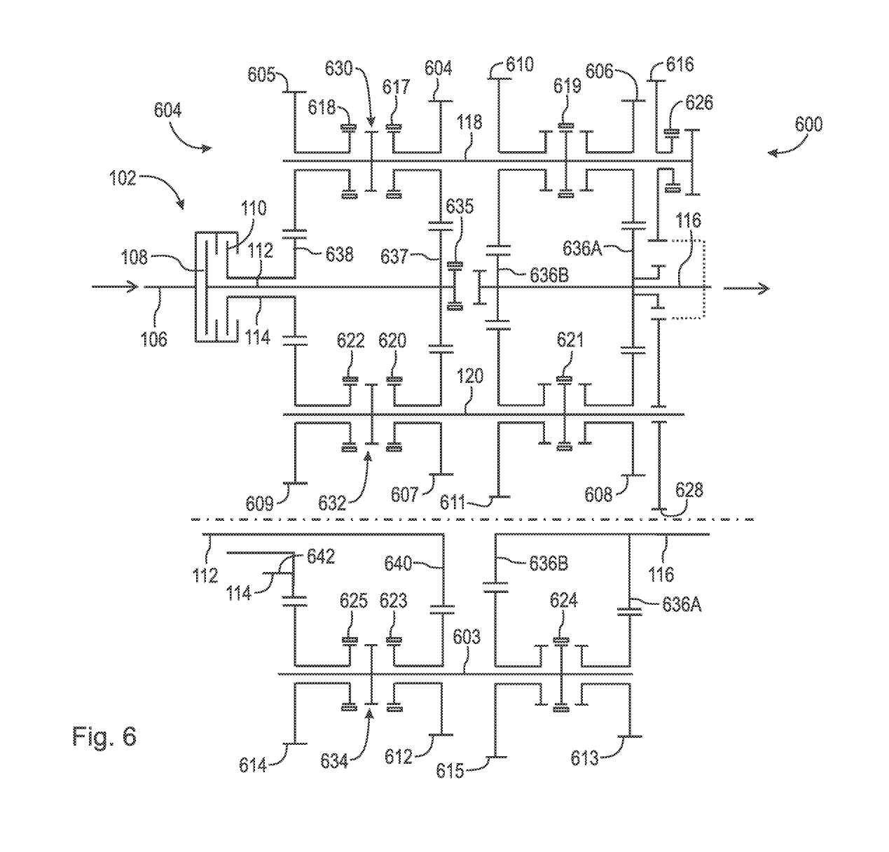

FIG. 6 is a schematic diagram of transmission assembly 600 including a dual clutch input, 14 forward speeds and two reverse speeds. Assembly 600 includes dual clutch assembly 102 and transmission 604. Transmission 604 includes: output shaft 116; lay shafts 118 and 120; lay shaft 603; gears 604 through 616; half synchronizer clutches 617 through 626; and idler gear 628 non-rotatably connected to lay shaft 120. Half synchronizer clutches 617 and 618 form full synchronizer clutch 630 and are arranged to: non-rotatably connect gears 604 and 605, respectively, to lay shaft 118; and disconnect gears 604 and 605, respectively, from lay shaft 118. Half synchronizer clutch 619 is arranged to: non-rotatably connect gears 606 and 610 to lay shaft 118, and disconnect gears 606 and 610 from lay shaft 118. Half synchronizer clutches 620 and 622 form full synchronizer clutch 632 and are arranged to: non-rotatably connect gears 607 and 609, respectively, to lay shaft 120; and disconnect gears 607 and 609, respectively, from lay shaft 120. Half synchronizer clutch 621 is arranged to: non-rotatably connect gears 608 and 611 to lay shaft 120, and disconnect gear 608 and 611 from lay shaft 118. Half synchronizer clutches 623 and 625 form full synchronizer clutch 634 and are arranged to: non-rotatably connect gears 612 and 614, respectively, to lay shaft 603; and disconnect gears 612 and 614, respectively, from lay shaft 603. Half synchronizer clutch 624 is arranged to: non-rotatably connect gears 613 and 615 to lay shaft 603, and disconnect gear 613 and 615 from lay shaft 603. Transmission 602 also includes half synchronizer clutch 635 arranged to non-rotatably connect input shaft 112 and output shaft 116. Transmission 504 includes forward output gears 636A and 636B. Gear 636A is meshed with gears 606, 608 and 613. Gear 634B is meshed with gears 610, 611 and 615. Gear 636A also is meshed with gear 616 arranged to provide at least one reverse gear ratio.

In an example embodiment, transmission 104 includes gears 637, 638, 640 and 642 non-rotatably connected to shafts 112, 114, 112 and 114, respectively. Gear 637 is meshed with gears 604 and 607, gear 638 is meshed with gears 605 and 609, gear 640 is meshed with gear 612, and gear 642 is meshed with gear 614.

Assembly 600 is arranged to provide gear ratios as follows:

1. First forward gear ratio: Close clutches 108, 617 and 619; and non-rotatably connect gears 604 and 606 to lay shaft 118.

2. Second forward gear ratio: Close clutches 110, 618 and 619; and non-rotatably connect gears 605 and 606 to lay shaft 118.

3. Third forward gear ratio: Close clutches 108, 620 and 621; and non-rotatably connect gears 607 and 608 to lay shaft 120.

4. Fourth forward gear ratio: Close clutches 110, 622 and 621; and non-rotatably connect gears 609 and 608 to lay shaft 120.

5. Fifth forward gear ratio: Close clutches 108, 617 and 619; and non-rotatably connect gears 604 and 610 to shaft 118.

6. Sixth forward gear ratio: Close clutches 110, 618 and 619; and non-rotatably connect gears 605 and 610 to shaft 118.

7. Seventh forward gear ratio: Close clutches 108, 620 and 621; and non-rotatably connect gears 607 and 611 to lay shaft 120.

8. Eighth forward gear ratio: Close clutches 110, 622 and 621; and non-rotatably connect gears 609 and 611 to lay shaft 120.

9. Ninth forward gear ratio: Close clutches 108, 623 and 624; and non-rotatably connect gears 612 and 613 to lay shaft 603.

10. Tenth forward gear ratio: Close clutches 110, 625 and 624; and non-rotatably connect gears 614 and 613 to lay shaft 120.

11. Eleventh forward gear ratio: Close clutches 108, 623 and 624; and non-rotatably connect gears 612 and 615 to lay shaft 603.

12. Twelfth forward gear ratio: Close clutches 110, 625 and 624; and non-rotatably connect gears 614 and 615 to lay shaft 120.

13. Thirteenth forward gear ratio: Close clutches 108 and 635; and non-rotatably connect shafts 112 and 116.

14. Fourteenth forward gear ratio: Close clutches 630 and 635.

15. First reverse gear ratio: Close clutches 108, 617 and 626; and non-rotatably connect gears 604 and 616 to lay shaft 118.

16. Second reverse gear ratio: Close clutches 110, 618 and 626; and non-rotatably connect gears 605 and 616 to lay shaft 118.

Each of transmissions 104 through 604 provides gear ratios as follows:

1. Total number of forward gear ratios=[(number of input shafts)×(the number of lay shafts)×(number of forward output gears non-rotatably connected to the output shaft)]+[(2)×(number of half synchronizer clutches arranged to non-rotatably connect the output shaft to an input shaft)].

2. The number of reverse speed ratios=(2)×(number of idler gears).

3. For example:
A. Transmission 204 provides eight forward gear ratios and two reverse gear ratios and includes: two input shafts (112 and 114), two lay shafts (118 and 120), two forward output gears (225A and 225B), and zero half synchronizer clutches arranged to non-rotatably connect the output shaft to an input shaft.
   i. Total number of forward gear ratios=(2)×(2)×(2)+0=8
   ii. Total number of reverse gear ratios=(2)×(1)=2
B. Transmission 304 provides ten forward gear ratios and two reverse gear ratios and includes: two input shafts (112 and 114), two lay shafts (118 and 120), two forward output gears (325A and 325B), and one half synchronizer clutches arranged to non-rotatably connect the output shaft to an input shaft.
   i. Total number of forward gear ratios=(2)×(2)×(2)+2=10
   ii. Total number of reverse gear ratios=(2)×(1)=2

Advantageously, transmissions 104 through 604 each eliminate a separate shaft for the idler gear. Specifically, the respective idler gear is non-rotatably connected to a lay shaft used for forward gear ratios. For example, in transmissions 104 and 504, idler gear 134 and 528, respectively, are connected to lay shaft 120 used for forward speed ratios. Thus, transmissions 104 through 604 advantageously reduce the respective space requirements for transmissions 104 through 604.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claim is:

1. A transmission, comprising:
first and second input shafts;
an output shaft;
a plurality of lay shafts;
a plurality of gears;
at least one forward output gear non-rotatably connected to the output shaft;
a plurality of half synchronizer clutches arranged to:
non-rotatably connect the plurality of gears to the plurality of lay shafts; and,
disconnect the plurality of gears from the plurality of lay shafts; and, an idler gear:
non-rotatably connected to a first lay shaft included in the plurality of lay shafts; and,
meshed with the at least one forward output gear so that:
when the idler gear rotates about its axis of rotation, the at least one forward output gear rotates about its axis of rotation; and,
when the at least one forward output gear rotates about its axis of rotation, the idler gear rotates about its axis of rotation, wherein:
for at least one reverse gear ratio, the idler gear is arranged to rotate the output shaft opposite a direction of rotation for the first or second input shaft.

2. The transmission of claim 1, wherein:
for a first reverse gear ratio, a first torque path from the first input shaft to the output shaft passes through the idler gear; and,
for a second reverse gear ratio, a second torque path from the second input shaft to the output shaft passes through the idler gear.

3. The transmission of claim 1, wherein:
the plurality of lay shafts consists of the first lay shaft and a second lay shaft;
the plurality of gears consists of first through sixth gears;
the plurality of half synchronizer clutches includes:
a first full synchronizer clutch arranged to non-rotatably connect the first and second gears to the first lay shaft;
a first half synchronizer clutch synchronizer clutch arranged to non-rotatably connect the third and fourth gears to the first lay shaft;
a second full synchronizer clutch arranged to non-rotatably connect the fifth and sixth gears to the second lay shaft; and,
a second half synchronizer clutch arranged to non-rotatably connect the first input shaft to the output shaft.

4. The transmission of claim 3, wherein the transmission provides six forward gear ratios and two reverse gear ratios.

5. The transmission of claim 1, wherein:
the plurality of lay shafts consists of the first lay shaft and a second lay shaft;
the plurality of gears consists of first through ninth gears;
the plurality of half synchronizer clutches includes:
a first full synchronizer clutch arranged to non-rotatably connect the first and second gears to the first lay shaft;
a first half synchronizer clutch synchronizer clutch arranged to non-rotatably connect the third and fourth gears to the first lay shaft;
a second full synchronizer clutch arranged to non-rotatably connect the fifth and sixth gears to the second lay shaft;
a second half synchronizer clutch arranged to non-rotatably connect the seventh and eighth gears to the second lay shaft; and,
a third half synchronizer clutch synchronizer clutch arranged to non-rotatably connect the ninth gear to the first lay shaft.

6. The transmission of claim 5, wherein the transmission provides eight forward gear ratios and two reverse gear ratios.

7. The transmission of claim 1, wherein:
the plurality of lay shafts consists of the first lay shaft and a second lay shaft;
the plurality of gears consists of first through ninth gears;
the plurality of half synchronizer clutches comprises:
a first full synchronizer clutch arranged to non-rotatably connect the first and second gears to the first lay shaft;
a first half synchronizer clutch synchronizer clutch arranged to non-rotatably connect the third and fourth gears to the first lay shaft;
a second full synchronizer clutch arranged to non-rotatably connect the fifth and sixth gears to the second lay shaft;
a second half synchronizer clutch arranged to non-rotatably connect the seventh and eighth gears to the second lay shaft; and,
a third half synchronizer clutch synchronizer clutch arranged to non-rotatably connect the ninth gear to the first lay shaft.

8. The transmission of claim 7, wherein:
the first input shaft is arranged to provide torque for odd-numbered gear ratios;
the plurality of half synchronizer clutches further consists of a third half synchronizer clutch arranged to non-rotatably connect the first input shaft and the output shaft; and,
the transmission provides ten forward gear ratios and two reverse gear ratios.

9. The transmission of claim 7, wherein:
the second input shaft is arranged to provide torque for even-numbered gear ratios;
the plurality of half synchronizer clutches further consists of a third half synchronizer clutch arranged to non-rotatably connect the second input shaft and the output shaft; and,
the transmission provides ten forward gear ratios and two reverse gear ratios.

10. The transmission of claim 1, wherein:
the plurality of lay shafts consists of the first lay shaft, a second lay shaft and a third lay shaft;
the plurality of gears consists of first through thirteenth gears;
the plurality of half synchronizer clutches comprises:
a first full synchronizer clutch arranged to non-rotatably connect the first and second gears to the first lay shaft;
a first half synchronizer clutch synchronizer clutch arranged to non-rotatably connect the third and fourth gears to the first lay shaft;
a second full synchronizer clutch arranged to non-rotatably connect the fifth and sixth gears to the second lay shaft;
a second half synchronizer clutch synchronizer clutch arranged to non-rotatably connect the seventh and eighth gears to the first lay shaft; and,
a third full synchronizer clutch arranged to non-rotatably connect the ninth and tenth gears to the third lay shaft;
a third half synchronizer clutch synchronizer clutch arranged to non-rotatably connect the eleventh and twelfth gears to the third lay shaft; and,
a fourth half synchronizer clutch arranged to non-rotatably connect the thirteenth gear to the first lay shaft.

11. The transmission of claim 10, wherein the transmission provides twelve forward gear ratios and two reverse gear ratios.

12. The transmission of claim 1, wherein:
the plurality of lay shafts consists of the first lay shaft, a second lay shaft and a third lay shaft;
the plurality of gears consists of first through thirteenth gears;
the plurality of half synchronizer clutches comprises:
a first full synchronizer clutch arranged to non-rotatably connect the first and second gears to the first lay shaft;
a first half synchronizer clutch synchronizer clutch arranged to non-rotatably connect the third and fourth gears to the first lay shaft;
a second full synchronizer clutch arranged to non-rotatably connect the fifth and sixth gears to the second lay shaft;
a second half synchronizer clutch synchronizer clutch arranged to non-rotatably connect the seventh and eighth gears to the first lay shaft; and,
a third full synchronizer clutch arranged to non-rotatably connect the ninth and tenth gears to the third lay shaft;
a third half synchronizer clutch synchronizer clutch arranged to non-rotatably connect the eleventh and twelfth gears to the third lay shaft;
a fourth half synchronizer clutch arranged to non-rotatably connect the thirteenth gear to the first lay shaft; and,
a fifth half synchronizer clutch arranged to non-rotatably connect the first input shaft to the output shaft.

13. The transmission of claim 13, wherein the transmission provides fourteen forward gear ratios and two reverse gear ratios.

14. The transmission of claim 1, further comprising:
a first number of half synchronizer clutches arranged to non-rotatably connect the output shaft to the first or second input shaft, wherein:
every forward output gear in the transmission is included in the at least one forward output gear;
the at least one forward output gear consists of a second number of forward output gears;
each forward output gear included in the at least one forward output gear is meshed with a respective gear from the plurality of gears so that:
when the respective gear rotates about its axis of rotation, the output shaft rotates; and,
when the output shaft rotates, the respective gear rotates about its axis of rotation;
every lay shaft in the transmission is included in the plurality of lay shafts;
the plurality of lay shafts consists of a third number of lay shafts; and,
a total number of forward speed ratios for the transmission is equal to a sum of:
a first product of [(a number of input shafts for the transmission)×(the second number)×(the third number)]; and,
a second product of [(two)×(the first number)].

15. The transmission of claim 1, wherein a total number of reverse gear ratios for the transmission is equal to a number of idler gears in the transmission multiplied by two.

16. A transmission, comprising:
first and second input shafts;
an output shaft;
a plurality of lay shafts;
a plurality of gears;
at least one forward output gear non-rotatably connected to the output shaft;
a plurality of half synchronizer clutches arranged to:
non-rotatably connect the plurality of gears to the plurality of lay shafts; and,
disconnect the plurality of gears from the plurality of lay shafts; and, an idler gear:
arranged to reverse a rotational direction of torque received by the first or second input shaft;
non-rotatably connected to a first lay shaft included in the plurality of lay shafts; and,
meshed with the at least one forward output gear so that:
when the idler gear rotates about its axis of rotation, the output shaft rotates; and,
when the output shaft rotates, the idler gear rotates about its axis of rotation, wherein:
for a first reverse gear ratio, first torque from the first input shaft to the output shaft passes through the idler gear; and,
for a second reverse gear ratio, second torque from the second input shaft to the output shaft passes through the idler gear.

17. The transmission of claim 16, further comprising:
a first number of half synchronizer clutches arranged to non-rotatably connect the output shaft to the first or second input shaft, wherein:
every forward output gear in the transmission is included in the at least one forward output gear;
the at least one forward output gear consists of a second number of forward output gears;
each forward output gear included in the at least one forward output gear is meshed with a respective gear from the plurality of gears so that:
when the respective gear rotates about its axis of rotation, the output shaft rotates; and,
when the output shaft rotates, the respective gear rotates about its axis of rotation;
every lay shaft in the transmission is included in the plurality of lay shafts;
the plurality of lay shafts consists of a third number of lay shafts; and,
a total number of forward speed ratios for the transmission is equal to a sum of:
a first product of [(a number of input shafts for the transmission)×(the second number)×(the third number)]; and,
a second product of [(two)×(the first number)].

18. The transmission of claim 16, wherein a total number of reverse gear ratios for the transmission is equal to a number of idler gears in the transmission multiplied by two.

19. A transmission, comprising:
a total number of inputs shafts equal to a first number;
one only output shaft;
a total number of lay shafts equal to a second number;
a plurality of gears for providing forward gear ratios in which the output shaft rotates in a same direction as the first or second input shaft;
a total number of forward output gears equal to a third number, each forward output gear:
non-rotatably connected to the one only output shaft; and,
meshed with a respective gear from the plurality of gears so that:
when the one only output shaft rotates, the respective gear rotates about its axis of rotation; and,
when the respective gear rotates about its axis of rotation, the one only output shaft rotates;
a plurality of half synchronizer clutches arranged to:
non-rotatably connect the plurality of gears to the plurality of lay shafts; and,
disconnect the plurality of gears from the plurality of lay shafts; and, one only idler gear:
arranged to reverse a rotational direction of torque received by the first or second input shaft;
non-rotatably connected to a first lay shaft included in the plurality of lay shafts; and,
meshed with at least one forward output gear so that:
when the idler gear rotates about its axis of rotation, the one only output shaft rotates; and,
when the one only output shaft rotates, the idler gear rotates about its axis of rotation, wherein:
the plurality of half synchronizer clutches includes a fourth number of half synchronizer clutches arranged to non-rotatably connect the output shaft to an input shaft; and,
a total number of forward speed ratios for the transmission is equal to a sum of:
a first product of [(the first number)×(the second number)×(the third number)]; and,
a second product of [(two)×(the fourth number)].

20. The transmission of claim 19, wherein a total number of reverse gear ratios for the transmission is equal to a number of idler gears in the transmission multiplied by two.
